(19) United States
(12) Patent Application Publication
(10) Pub. No.: US 2013/0117075 A1
(43) Pub. Date: May 9, 2013

(54) PROJECT COMPLIANCE ASSESSMENT

(71) Applicants: Richard Brown, Bristol (GB); Marco Casassa Mont, Bristol (GB); Kieran Mccorry, (US); Nikolaos Papanikolaou, Bristol (GB); Siani Pearson, Llanvaches (GB); Prasad V Rao, Metuchen, NJ (US); Tomas Sander, New York, NY (US)

(72) Inventors: Richard Brown, Bristol (GB); Marco Casassa Mont, Bristol (GB); Kieran Mccorry, (US); Nikolaos Papanikolaou, Bristol (GB); Siani Pearson, Llanvaches (GB); Prasad V Rao, Metuchen, NJ (US); Tomas Sander, New York, NY (US)

(21) Appl. No.: 13/289,747

(22) Filed: Nov. 4, 2011

(51) Int. Cl. G06Q 10/06

(52) U.S. Cl. 705/7.39

(57) ABSTRACT

Compliance of a project is assessed by generating a graph including nodes representing attributes of the project, and populating a subset of nodes in the graph with attribute values of the project. A rule applicable to the subset of nodes is identified and applied to determine whether the attribute values comply with the rule.

### BACKGROUND

Projects are often required to comply with corporate policies, laws, and regulations. To ensure proper compliance, projects are often analyzed to detect compliance risks such that necessary corrections can be implemented.

### BRIEF DESCRIPTION OF THE DRAWINGS

FIG. 1 is a diagram of an example architecture for a project management system.

FIG. 2 is a diagram of an example method for the system shown in FIG. 1 to assess project compliance.

FIG. 3 is a diagram of an example computer system.

### DETAILED DESCRIPTION

The present subject matter is now described more fully with reference to the accompanying figures, in which several implementations of the subject matter are shown. The present subject matter may be embodied in many different forms and should not be construed as limited to the implementations set forth herein. Rather these implementations are provided so that this disclosure will be complete and will fully convey principles of the subject matter.

It is often desirable for businesses to detect compliance risks in projects early in the projects' lifecycles so that necessary corrections can be made early on rather than later when corrections may be more expensive to implement. Assessing compliance based on the partial information that is available in the early stages of a project may prove difficult. Thus, a way to assess a project's compliance based on partial information of the project is desirable.

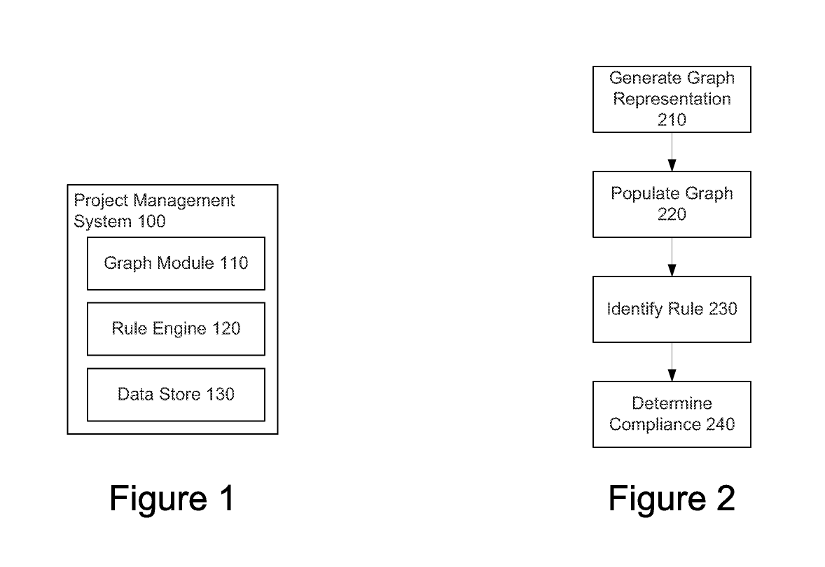

FIG. 1 illustrates one implementation of a system architecture for a project management system 100 that dynamically assesses compliance risks of a project and provides guidance regarding the detected compliance risks. Compliance may refer to a state of a project in which the project is in accordance with applicable policies, guidelines, specifications, regulations, or legislation. The project management system 100 includes a graph module 110, a rule engine 120, and a data store 130.

The graph module 110 defines projects using graph representations. A graph includes a collection of nodes that are interconnected by edges. In one example, a project is represented (or defined) using one or more hierarchical directed acyclic graphs (DAGs) or a DAG-based data structure. In a DAG nodes are interconnected through directed edges without forming any directed cyclic path. A DAG includes at least one node that only has outgoing edges (called a root node), and each non-root node in the DAG has a path leading to it from a root node (called the root path of the node). Nodes with a same root path length (e.g., same number of nodes in the root paths) are considered in a same hierarchy level. Each node in the graph representation can represent (or define) one or more attributes of the project and store one or more attribute values of the represented attributes. Similarly, each attribute of the project can be represented by one or more nodes (e.g., a sub-DAG) in the graph representation. A directional edge from a node (called the parent node) to another node (called the child node) represents a directional relationship between the two nodes. For example, in a graph representation of a marketing campaign project, a node representing a destination country may have an edge leading to anode representing a destination state or city in the destination country. Because most projects include interdependent action items, DAGs are well suited to represent such projects.

A project graph representation can include rules applicable to one or more nodes in the graph representation. A rule can be associated with one or more applicable nodes (e.g., a sub-DAG) in the graph representation. In one example, the syntactic structure of a rule is: IF CONDITION THEN ACTION. The CONDITION and ACTION clauses are logic expressions over attribute values of the project. The logic expression of the CONDITION clause (also called the “condition expression”) evaluates to true or false based on the values of the involved attributes whereas the ACTION clause specifies a set of actions that need to be performed. If the condition expression of a rule evaluates to true, the rule is triggered (or fired) and as a result the actions specified in the ACTION clause will be performed. The condition expression of a rule can involve the attribute values of one or more nodes in a same graph or in multiple graphs. For example, a graph representation may include multiple DAGs such as a DAG including nodes for technical attributes, a DAG including nodes for fiscal attributes, and a DAG including nodes for geographic attributes. The condition expression of a rule in the graph representation can simultaneously take into account attribute values in nodes in some or all DAGs. In one example, to facilitate the condition expression to evaluate attribute values of multiple nodes, a graph can include AND nodes and OR nodes that lead to multiple child nodes.

The ACTION clause of a rule can specify, among others, two types of actions: informational actions and narrowing actions. An informational action triggers one or more outputs, such as displaying a warning or help message (e.g., “Sharing users' personal information with an outside vendor violates company privacy policy, unless preapproved by the users.”) to a user. A narrowing action forces one or more attributes of the underlying project to be set to certain values (or value ranges), and thereby restricting the attribute values the corresponding nodes can assume.

The graph representation of a project can be generated according to a pre-existing project template, and then nodes in the graphs can be populated with attribute values as they are provided (e.g., by a user). A project template is a pre-generated graph of unpopulated nodes (e.g., without attribute values) that can be used to define projects. Different types of projects (e.g., marketing campaign, corporate finance, research and development) can have different project templates. Alternatively or additionally, the graph representation can be generated by reusing a pre-existing graph representation (e.g., of a similar project), or be dynamically defined (or created) as information about the project is provided (e.g., by a user creating the project).

The graph module 110 provides a graphical user interface (UI) for users to create and/or edit projects. The UI has one or more intuitive themes for the users to view and/or edit the graph representations of the projects. One example UI theme displays a layout of the node graphs in the project representation. Another example UI theme displays the graphs in a dual-pane window, with the nodes listed on one pane according to their hierarchical order, and information about a selected node on the other pane. Each node may have properties such as a short name, a long name, a description of the represented project attribute(s), a question designed to solicit the vain of the represented attribute, an attribute value, and an attribute type. An attribute type is the data type of the attribute value, and can be a primitive data type (e.g., an integer, a Boolean, a string) or a compound type (e.g., a collection of attribute types). The user can select or mouse-over the nodes in the UI to view properties of the nodes. For example, a node may be displayed along with a label containing its short name, and the label may expand to display the long name (or the description) when the user selects or scrolls over the node.

In order to define a project, a user may start off by defining (or populating) a root node in the graph representation with a value of the project attribute represented by the root node, and step through the nodes down the hierarchy to populate nodes along the way. To facilitate the process, when a user selects an unpopulated node, the UI may prompt the user with a question associated with the node, and populate the node using the answer provided by the user. For example, when a user browses to anode in the graph representation, the graph module 110 displays a dialog box prompting the user to answer the associated question, and stores the received answer as the attribute value of the node. In one example, the graph module 110 verifies whether the user input is consistent with the attribute type of the current node. If the type verification is successful, the graph module 110 sets the attribute value according to the user input. Otherwise, if the type verification is unsuccessful, the graph module 110 notifies the user that the input is inconsistent with the attribute type, and gives the user an option to correct. In one example, the graph module 110 visually indicates in the UI those node(s) that the user can interact with (e.g., by coloring such nodes differently compared to the other nodes), and grays out those nodes that the user cannot interact with. The graph module 110 may also provide a text editor for viewing/editing the project representation.

The graph module 110 also provides a UI theme for users to create and/or edit project templates. Using this UI, a user can add, modify, and delete graphs, nodes and edges in the representation. The user can group nodes differently and change their hierarchies. For example, the user can move nodes to different DAGs according to their topics (e.g., moving nodes related to technical topics such as encryption and computing environment in one DAG, and moving nodes related to legal topics such as mandatory review and authority notification in another DAG). The user can also change the sequence of the graphs as they are shown in the graph representation. Project templates may enhance productivity by allowing graphs in the templates to be reused in defining projects.

The UI themes provided by the graph module 110 also enable users (e.g., domain experts) to create rules and attach rules to nodes in the project templates. In one example, the UI displays rules as visual artifacts (e.g., flags) adjacent to the associated nodes. As a result, nodes that are either not associated (or annotated) with rules or annotated with few rules become apparent to the users, prompting the users to avoid (or reduce) gaps in compliance assessments by ensuring that no rule is missing for such nodes. In addition, by showing the rules integrated in the graphs defining the project, the graph module 110 beneficially enables the users to construct a mental model of project compliance based on the logical structure of the project, which beneficially enables the users to create additional compliance assessment rules.

Rules and project information (e.g., graph representation) can be reused to enhance efficiency. Rules/project information reuse tends to be beneficial among similar projects (e.g., sharing similar node patterns and/or project attributes). Similar projects can be conveniently identified by measuring similarities among project graph representations. Example similarity measures include the edit distance (i.e., the number of operations required to transform one graph representation into the other) and the number/portion of shared project attributes between two project graph representations. If the similarity measure between two projects is below a predetermined threshold value, then the two projects are considered similar. As a result, the user can reuse rules/information in one of the two projects (called the “source project”) to define the other (called the “destination project”). For example, the user can create the graph representation of the destination project by modifying the graph representation of the source project.

The rule engine 120 dynamically identities rules with condition expressions that can be readily evaluated as the graph representation of a project is populated with information defining the project, and fires those rules with condition expressions satisfied (i.e., condition expressions evaluate to true). In one example, while a user is defining a project by populating the corresponding graph representation, the rule engine 120 continuously examines the available project information to dynamically identify rules whose condition expressions can be evaluated based on the partial information. The fired rules may provide feedback about potential compliance risks and guidance for correction, or populate other nodes with certain attribute values (or ranges of values). As a result, the rule engine 120 beneficially enables early detection of compliance risks over incomplete project information and provides appropriate compliance guidance by firing rules as soon as graphs in the project representation have been sufficiently populated (e.g., by a user who wishes to assess that project for compliance). Graphs defining a project are considered “sufficiently populated” with respect to a rule if nodes in the graphs associated with the rule are sufficiently defined. That is, enough elements of the condition expression have been defined such that the CONDITION clause of the rule can be evaluated to be true or false.

In one example, in order to ensure that once a rule fires, the subsequent introduction of additional project information would not change the result of this firing, a property called monotonicity, the rule engine 120 prohibits nodes that have been defined from being redefined later. When subsequent project information calls for changes of a previously defined project attribute, the rule engine 120 rolls back the state of the project to the point where the project attribute that needs to be updated was not yet defined, and redo all the subsequent assignments, and thereby ensures monotonic. This arrangement also facilitates termination and determinism of the project management system 100.

The data store 130 stores data used by the project management system 100. Examples of the data stored in the data store 130 include the project templates, the project representations, and the associated rules. The data store 130 may be a database stored on a non-transitory computer-readable storage medium.

FIG. 2 is a flow diagram that shows an example method for the project management system 100 to perform compliance assessment for a project. As shown, in step 210, the graph module 110 generates a graph representation for the project. Graphs (e.g., hierarchical directed acyclic graphs) in the representation include nodes that represent attributes of the project. In step 220, the graph module 110 populates nodes in the graph with attribute values of the project entered by a user. In one example, the graph module 110 verifies that the attribute values entered are consistent with the types of the corresponding nodes before populating the nodes. In step 230, the rule engine 120 identifies a rule applicable to the populated nodes from rules in the graph representation. In one example, the rule engine 120 continuously examines project information as the user populates the graph representation and identifies the rule from those not yet fired in the graph representation. In step 240, the rule engine 120 applies the rule to attribute values of the subset of nodes to determine whether the attribute values comply with the rule.

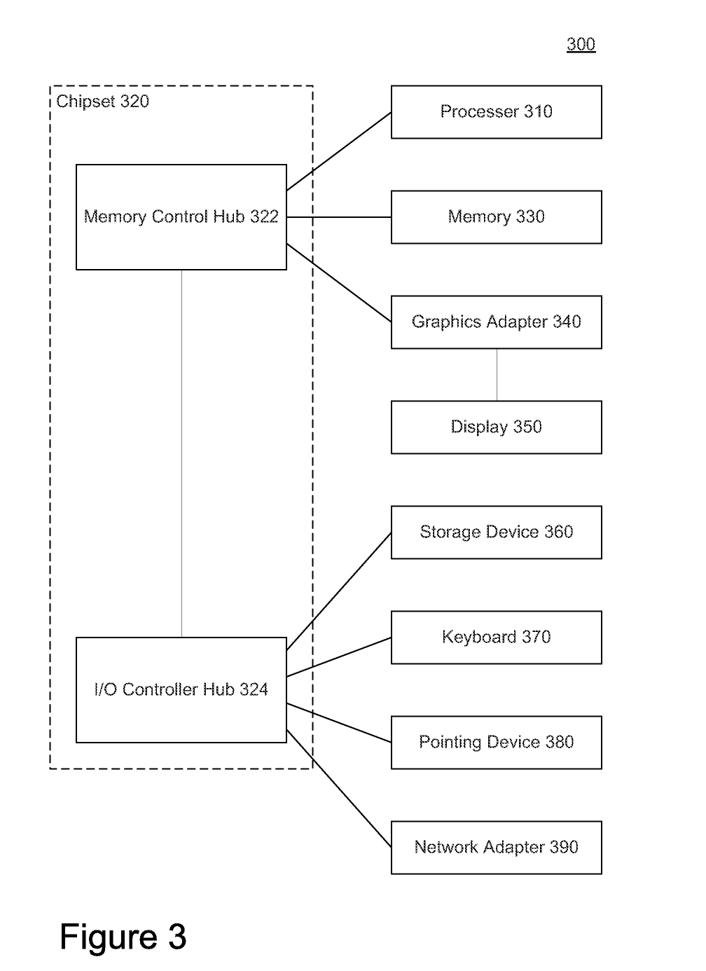

In one example, the entities shown in FIGS. 1 and 2 are implemented using one or more computer systems. FIG. 3 is a high-level block diagram illustrating an example computer system 300. The computer system 300 includes at least one processor 310 coupled to a chipset 320. The chipset 320 includes a memory controller hub 322 and an input/output (I/O) controller hub 324. A memory 330 and a graphics adapter 340 are coupled to the memory controller hub 322, and a display 350 is coupled to the graphics adapter 340. A storage device 360, a keyboard 370, a pointing device 380, and a network adapter 390 are coupled to the I/O controller hub 324. Other implementations of the computer system 300 have different architectures.

The storage device 360 is a non-transitory computer-readable storage medium such as a hard drive, compact disk read-only memory (CD-ROM), DVD, or a solid-state memory device. The memory 330 holds instructions and data used by the processor 310. The pointing device 380 is a mouse, track ball, or other type of pointing device, and is used in combination with the keyboard 370 to input data into the computer system 300. The graphics adapter 340 displays images and other information on the display 350. The network adapter 390 couples the computer system 300 to one or more computer networks.

The computer system 300 is adapted to execute computer program modules for providing functionality described herein. As used herein, the term “module” refers to computer program logic used to provide the specified functionality. Thus, a module can be implemented in hardware, firmware, and/or software. In one implementation, program modules are stored on the storage device 360, loaded into the memory 330, and executed by the processor 310.

The types of computer systems 300 used by entities can vary depending upon the implementation and the processing power required by the entity. For example, the project management system 100 might comprise a mobile telephone with limited processing power. A computer system 300 can lack some of the components described above, such as the keyboard 370, the graphics adapter 340, and the display 350.

One skilled in the art will recognize that the configurations and methods described above and illustrated in the figures are merely examples, and that the described subject matter may be practiced and implemented using many other configurations and methods. It should also be noted that the language used in the specification has been principally selected for readability and instructional purposes, and may not have been selected to delineate or circumscribe the disclosed subject matter. Accordingly, the disclosure of the described subject matter is intended to be illustrative, but not limiting, of the scope of the subject matter, which is set forth in the following claims.

1. A method for assessing compliance of a project, comprising:
with a processing device:
generating a graph for representing the project, wherein the graph comprises a plurality of nodes representing a plurality of attributes of the project;
populating a subset of nodes in the graph with attribute values of the project;
identifying a rule applicable to the subset of nodes in a plurality of rules applicable to nodes in the graph; and
applying the rule to attribute values of the subset of nodes to determine whether the attribute values comply with the rule.

2. The method of claim 1, further comprising:
notifying, responsive to a determination that at least one of the attribute values is noncompliant to the rule, a user associated with the project of the noncompliance.

3. The method of claim 1, wherein the graph comprises a directed acyclic graph.

4. The method of claim 1, further comprising:
verifying that an attribute value is consistent with a type of a node before populating the node with the attribute value.

5. The method of claim 4, further comprising:
prompting a user to provide the attribute value by displaying a question associated with the node; and
receiving the attribute value from the user as an answer of the question.

6. The method of claim 1, wherein identifying the rule comprises determining that nodes in the subset are sufficient to evaluate a condition expression of the rule.

7. The method of claim 1, wherein applying the rule comprises performing an action of the rule, the action comprising at least one of the following:
providing a message regarding whether the attribute value complies with the rule; and
restricting a value of a node in the graph.

8. A non-transitory computer-readable storage medium having computer program instructions recorded thereon for assessing compliance of a project, the computer program instructions comprising instructions for:
generating a graph representation for representing the project, wherein a graph in the graph representation comprises a plurality of nodes representing a plurality of attributes of the project;
defining a subset of nodes in the graph with attribute values of the project;
identifying a rule applicable to the subset of nodes in a plurality of rules applicable to nodes in the graph; and
applying the rule to attribute values of the subset of nodes to determine whether the attribute values comply with the rule.

9. The storage medium of claim 8, wherein the computer program instructions further comprise instructions for:
notifying, responsive to a determination that at least one of the attribute values is noncompliant to the rule, a user associated with the project of the noncompliance.

10. The storage medium of claim 8, wherein the graph comprises a directed acyclic graph.

11. The storage medium of claim 8, wherein the computer program instructions further comprise instructions for:
verifying that an attribute value is consistent with a type of a node before populating the node with the attribute value.

12. The storage medium of claim 11, wherein the computer program instructions further comprise instructions for:
prompting a user to provide the attribute value by displaying a question associated with the node; and
receiving the attribute value from the user as an answer of the question.

13. The storage medium of claim 8, wherein the instructions for identifying the rule comprise instructions for determining that nodes in the subset are sufficient to evaluate a condition expression of the rule.

14. The storage medium of claim 8, wherein the instructions for applying the rule comprise instructions for performing an action of the rule, the action comprising at least one of the following:
providing a message regarding whether the attribute value complies with the rule; and
restricting a value of a node in the graph.

15. A computing system for assessing compliance of a project, comprising:
a processor; and
a storage device coupled to the processor, the storage device comprising:
a graph module to generate a directed acyclic graph for representing the project and populate a subset of nodes in the graph with attribute values of the project, wherein the graph comprises a plurality of nodes representing a plurality of attributes of the project; and
a rule engine to identify a rule applicable to the subset of nodes in a plurality of rules applicable to nodes in the graph, and apply the rule to attribute values of the subset of nodes to determine whether the attribute values comply with the rule.
